(19) United States
(12) Patent Application Publication
(10) Pub. No.: US 2015/0247349 A1
(43) Pub. Date: Sep. 3, 2015

(54) APPARATUS FOR THE MECHANICAL AND AUTOMATIC CLOSURE OF SLIDING DOORS

(71) Applicant: Terno Scorrevoli s.r.l., Varedo (MB) (IT)

(72) Inventor: Giovanni TERNO, Varedo (MB) (IT)

(21) Appl. No.: 14/627,768

(22) Filed: Feb. 20, 2015

(30) Foreign Application Priority Data
Feb. 28, 2014 (IT) MI2014A000312

(51) Int. Cl. E05D 15/06

(52) U.S. Cl. CPC E05D 15/063; E05D 15/0652

(57) ABSTRACT

An apparatus for the mechanical and automatic closure of sliding doors separating rooms and premises, in particular for sliding doors (36) attached to carriages (12) with wheels (34), and designed for example for service spaces for the disabled, for hospitals and public premises, comprising a sliding guide (10) consisting of a first or external profile (14) and a second or internal profile (22) positioned and stabilised in the outer profile with an inclined orientation and provided with sections (28-28′) on which said wheels (34) of said carriages (12) rest and slide.

The present invention relates to an apparatus for the mechanical and automatic closure of sliding doors.

More in particular, the present invention relates to an apparatus as defined above, especially suitable to be used with sliding doors separating rooms or premises which makes it possible to avoid the use of electrically powered systems to move said doors into a closed position.

It is well known that for the temporary isolation of some premises automatically closing sliding doors are often installed; doors of this kind, which are designed to facilitate the user, can be found for example in service spaces, especially for people with disabilities, as well as in hospitals, in restaurants and in public places reserved for smokers. In particular, electrified systems are known of and widespread which make it possible to obtain, by means of sensors, switches and the like, both the opening and the closing of said automatic sliding doors, guided above and below along special rails or sliding seats. These solutions however have some drawbacks which limit their diffusion, starting with the very high costs.

In addition, these solutions are constructively complex given the need to provide an electrical connection on both sides of the door for the motor moving them, relative sensors and/or switches.

Other, simpler solutions provide for the mechanical automation of the movement limited to the closing phase of the door, in such cases the need for electric power thus being excluded. A well-known example of this kind provides for the use of a rail, which is attached to the wall with an inclined orientation; one or more carriages connected underneath to the door to be moved, sliding on the rail by gravity. The main drawback of this solution is related to the installation phase, during which the operator determines the inclination of the rail based solely on experience. Situations may thus arise in which, for various reasons, such inclination of the rail does not prove optimal, with the result of achieving an insufficient closure of the door or, conversely, of moving the door too quickly which thus reaches the end of stroke hitting noisily against the abutment provided. All this results in the need for sometimes complex and expensive repair operations. In any case, even in the presence of a correct inclination of the rail attached to the wall, braking the closing door proves constructively complex, a rack device with a braking gear being used for such purpose. It should also be noted that such known solutions only allow attachment of the guide rail to the wall whereas it would be extremely useful, in some situations, to be able to attach said rail to the ceiling.

U.S. Pat. No. 3,805,450 discloses the solution of creating a device suitable to permit the sliding by gravity of doors hung along upper inclined rails, especially for use on commercial coolers and freezers where the doors are very limited in weight, are opened by the user to take out products and then close automatically. Said solution comprises a pair of profiles wherein the innermost, attached at the top to the inside of the corresponding upper face of the external profile is inclined and defines, at the free ends of the metal sheets, simple hook-shaped folds to form the housing and sliding seats of the wheels of each door. The folds mentioned constitute a viable solution as the weight of the doors is reduced; otherwise, simple folded seats would not be suitable and would give rise to dangerous wobbling should they have to support real doors or partition doors of rooms in sliding.

The purpose of the present invention is to overcome the drawbacks complained of above.

More in particular, the purpose of the present invention is to provide an apparatus for the mechanical and automatic closure of sliding doors suitable to permit easy and fast attachment of the guide rail to the wall without having to take into account in advance the inclination of said rail.

Another purpose of the invention is to provide an apparatus as defined above suitable to be easily attached, if needed, to the ceiling as well as to the wall of a room.

A no less important purpose of the invention is to provide an apparatus for the mechanical and automatic closure of sliding doors in which the braking of the door is achieved in a simple, effective manner and with means which are not structurally complex.

These and other purposes are achieved by the apparatus for the mechanical and automatic closure of sliding doors according to the main claim.

The construction and functional characteristics of the apparatus for the mechanical and automatic closure of sliding doors of the present invention will be more clearly comprehensible from the detailed description below in which reference is made to the appended drawings which show a preferred and non-limiting embodiment and wherein:

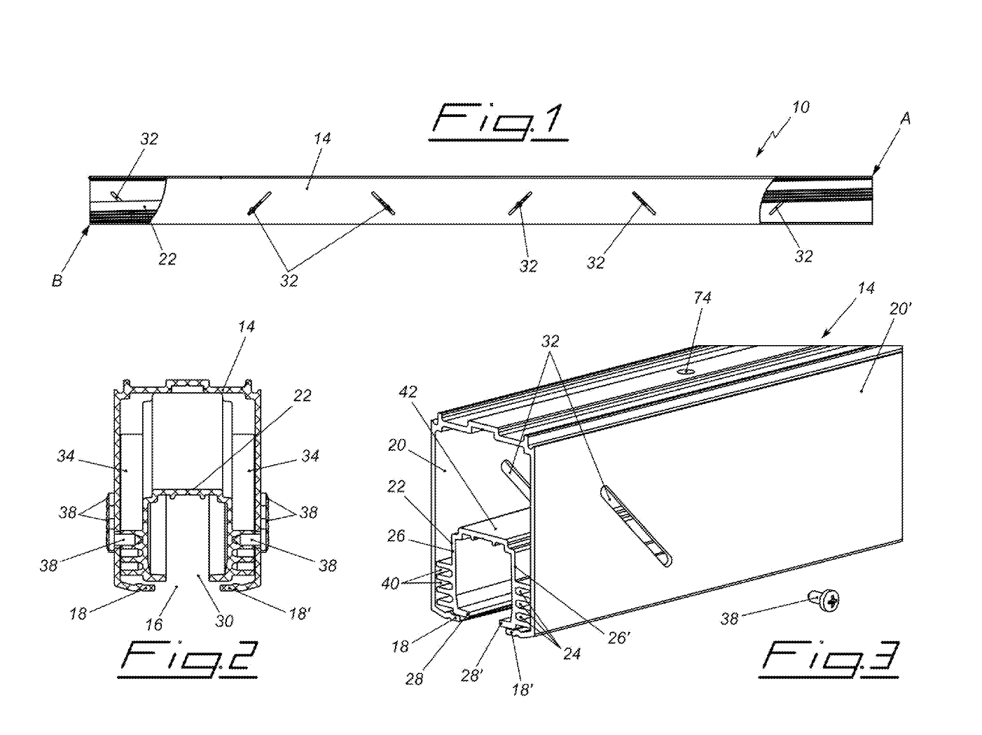

FIG. 1 shows schematically, in a side view in partial cross-section, the sliding rail of the carriages attached to the top front of the sliding door according to the invention;

FIG. 2 shows schematically, in transversal cross section, the same rail, to illustrate the construction thereof which comprises two profiles inserted inside one another;

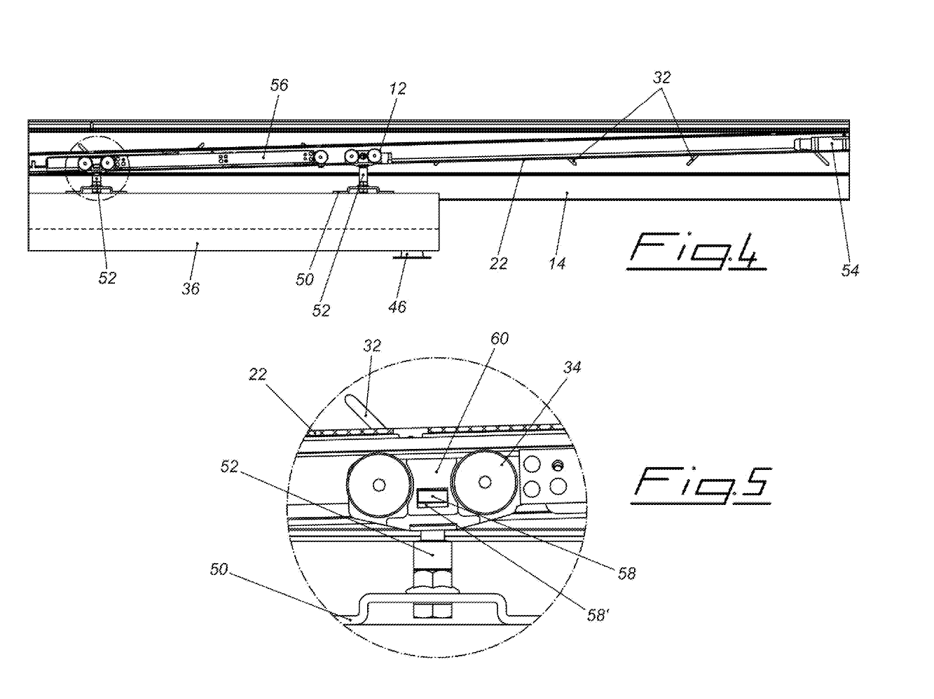

FIG. 3 shows schematically, in a perspective view, the rail according to FIG. 2;

FIG. 4 shows schematically, a longitudinal cross-section of the same rail and of the carriages which are connected to the upper part of the sliding door;

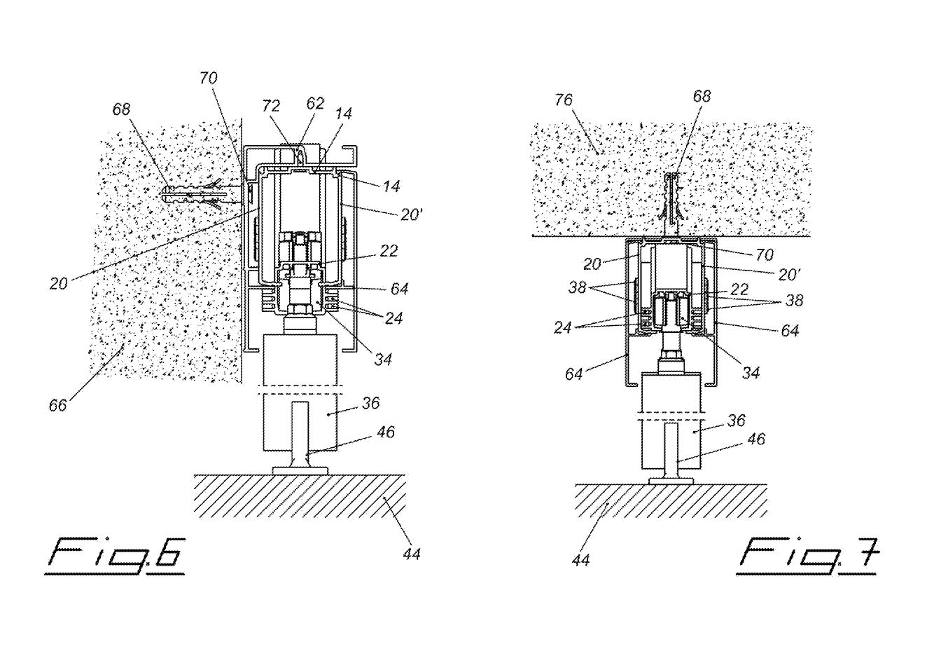

FIG. 5 is a partial enlargement of FIG. 4, highlighting one of the carriages and the means connecting it to the top of the sliding door;

FIG. 6 shows schematically, in partial transversal cross section, said rail in the condition providing for its attachment to the wall;

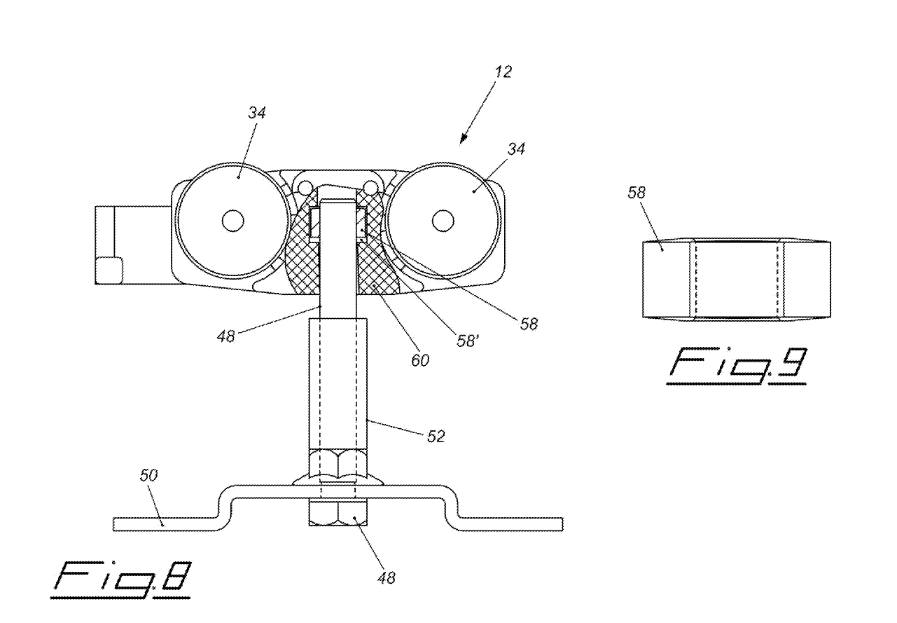

FIG. 7 shows schematically, in partial transversal cross-section, said rail in the possible alternative condition providing for its attachment to the ceiling;

FIG. 8 shows schematically, in a side view in partial cross-section, one of the carriages sliding in the aforementioned rail;

FIG. 9 shows schematically, in a side view, the nut with a rubber washer predisposed to tilt and incline in relation to the carriage.

With initial reference to FIGS. 1 to 3, the apparatus for the mechanical and automatic closure of sliding doors of the present invention comprises a sliding guide, globally denoted by reference numeral 10 in FIG. 1, inside which two or more spaced out carriages of the known type slide and which are connected at the bottom to the door to be moved; one of said carriages is illustrated in detail in FIG. 8 where it is indicated by reference numeral 12.

The sliding guide 10 comprises a first or external profile 14, with a substantially quadrangular cross-section, provided on the lower face with a longitudinally extending slot 16. Said lower face of the first profile defines, therefore, two opposite sections 18 and 18′ separated by the slot 16; the sections 18 and 18′ constitute end strips of the opposite vertical walls or sides referred to as 20 and 20′, bent at 90° in the direction of the longitudinal axis of the first profile 14.

Inside said first profile 14 a second or internal profile 22 is placed, having substantially the same configuration as the first as regards cross-section but smaller; in particular, according to the preferred embodiment in FIGS. 2 and 3, the total height of the second profile 22 corresponds approximately to half the height of the first profile 14. The overall width of the second profile 22 is such as to correspond to the internal width of the first profile 14, the second profile 22 being provided with a plurality of overlapping and equidistant parallel fins 24, projecting outwards from its opposite vertical walls marked as 26 and 26′, for the entire length of said walls. The lower end of the latter is folded at 90° in the direction of the longitudinal axis, similarly to the first profile 14 to form opposites sections 28 and 28′ separated by a longitudinally extending central slot 30, as in FIGS. 2 and 3. The fins 24 projecting from the vertical walls 26 and 26′ of the second profile 22 perform a constant centring function of the latter in the first profile and, as described below, form the seats for stabilisation means of said profiles. The opposite vertical walls or sides 20 and 20′ of the external profile 14 are provided with a plurality of slots 32 arranged diagonally and extending about halfway up said walls along their central area; as may be noted in particular in FIG. 1, the slots 32 alternate with one another as regards inclination.

The internal profile 22 is positioned in the first profile 14 so that its opposite sections 28 and 28′ rest, at one end, on corresponding sections 18 and 18′ of said first profile; the respective slots 16 and 30 are aligned. Said internal profile houses the carriages 12, in particular the wheels of said carriages indicated by reference numeral 34; as may be seen in particular in FIGS. 2, 6 and 7, the wheels 34 abut on the inner face of the sections 28, 28′ of the second profile, sliding on them. Given that the door must be made to close automatically immediately after opening, the inner profile 22 is placed and stabilised in an inclined position in the external profile 14, as shown in FIG. 1; this allows the door, schematically represented as number 6 in FIGS. 4, 6 and 7, to move spontaneously in closure thanks to the carriages 12 to which it is attached, since the latter descend by gravity with the wheels 34 on the higher and lower side of the internal profile 22, suitably inclined. This inclination is advantageously obtained and maintained over time by the aforementioned stabilisation means of the internal profile in the external profile 14; said means preferably consist of self-tapping screws 38 which, inserted through the slots 32, screw into the longitudinally extending throat 40 (FIG. 3) defined by two superposed fins 24 of the internal profile 22. The necessary and preordained inclination to attribute to said internal profile is obtained with precision thanks to the fact that the screws 38 can be slidingly positioned in the slots 32 before their blocking, to cross one or other of the throats 40 at the most appropriate height.

By way of example, FIG. 1 shows the internal profile 22 which, at one end, abuts in the lowest possible point indicated by “B” of the external profile 14, resting with the sections 28 and 28′ on the sections 18 and 18′ as described above, while at the opposite end it abuts at the highest point possible, “A”, with its upper side indicated as number 42 in FIG. 3, said external profile.

Advantageously, the fact that the slots 32 extending diagonally along the opposite sides 20 and 20′ of the external profile 14 alternate as regards their inclination, prevents the internal profile 22 from moving or sliding in relation to the external profile it is inserted in as a result of possible stress and even strong vibration caused by the movement of the door 36. Depending on the width of the latter, the external 14 and internal 22 profiles are cut to size in advance, to ensure a proper inclination for the sliding of the carriages 12;

as a guideline, a drop of between 30 and 40 mm should be considered for the internal profile 22 compared to the external profile 14 to form overall a sliding guide 10 about three metres.

During the stroke of the door 36 by means of the carriages 12 driven upwards for its manual opening or downwards, by the automatic closure of said door, it must remains constantly at the same level as the floor, shown schematically as number 44 in FIGS. 6 and 7; for completeness a guide 46 is shown in said figures, in itself known, which projects from the floor 44 to guide said door in the bottom area during the phases of its movement.

Each carriage 12 comprise a conventional bolt 48, which extends downwards in the direction of said door, projecting through the slots 16 and 30 of the profiles and bearing a shaped plate 50; through the latter each carriage 12 is connected, for example with screws, to the top edge of the door 36 to be supported. As a result, in order to compensate the height difference due to the inclination of the internal profile 22 inside which said carriages 12 slide, the bolt 48 of one or more of them is advantageously fitted with a spacer 52; said spacer, visible in particular in FIGS. 5 and 8, is fitted on the bolt 48 and is thus interposed between each carriage 12 and the relative shaped plate 50; this way, as shown in FIG. 4, the door indicated therein as number 36 maintains its alignment with the plane defined by the floor 44. This solution is clearly visible in FIG. 1, which shows for example just two carriages 12: the further forward one, placed near or at the lowest point of the internal profile 22, has an appreciably lower spacer 52 than that of the other carriage 12 which is instead rearward and placed in the highest point of said profile. At the highest point of the internal profile 22, i.e. at the end of the upward stroke of the carriages 12 which corresponds to the maximum opening position of the door 36, a buffer 54 is preferably placed in the sliding guide 10, for example, of the type with coil spring or fluid-activated piston, which first of all prevents the violent impact of said door when it reaches the opening end stop and, at the same time, helps the downward return starting with the carriage 12 which abutted against it.

On the opposite side too, i.e. in the part of the sliding guide 10 next to the lowest point of the internal profile 22, a damper piston 56 is placed, e.g. of the fluid type consisting of silicone; said piston, in itself known, is triggered by one of the carriages 12 which, during its descent compresses the exposed rod and attenuates the closing stroke of the door 36; during the subsequent phase of opening said door, a conventional actuator pulls a hook in a shaped cavity which, at the end of the stroke, rotates partially and frees itself in the known manner of said actuator.

According to a further advantageous characteristic of the invention, the nut, indicated by number 58, of the bolt 48, which is conventionally positioned in a seat 58′ of the carriage 12, is shaped so as to be able to incline inside said seat, which is suitably sized to leave the necessary space; this allows the nut 58 to adapt adequately to the inclination which the carriage 12 assumes, sliding along the internal inclined profile. In accordance with this requirement, said nut 58 defines on the opposite faces a slight convexity or “cradle” shaping; combined with a deformable rubber washer 60, which circumscribes said nut and part of the bolt adjacent to it, the nut 58 may thus tilt the in the seat 58′ in relation to the carriage 12 by a sufficient amount to offset the inclination of said carriage, to maintain the vertical position of the bolt 48 bearing the shaped plate 50 connected to the door 36. This condition is illustrated in FIG. 8, which also shows an enlarged deformation of the rubber washer 60 compared to the condition illustrated in FIG. 5.

The apparatus for the mechanical and automatic closure of sliding doors of the invention, basically formed of the sliding guide 10 which comprises the external profile 14 and the internal profile 22, can be easily attached not just to the wall, but also to the ceiling of a room.

In the first case, as illustrated in FIG. 6, shaped supports 62, 64 are elastically attached to the external profile 14 in preordained points which define conventional coupling seats; the first of said supports is advantageously L-shaped and is designed to abut, with its vertical branch, the wall indicated as number 66, to which it is constrained by expansion plugs 68 and relative screws 70. Operatively, the shaped support 62 is first attached to said wall 66 and then the sliding guide 10 is connected to the horizontal branch of the support; the guide, in particular, is connected to said support 62 by means of conventional screws 72, inserted in holes 74 (one of which is visible in FIG. 3) created along the upper front of the external profile 14. The second shaped support 64 is similarly attached to the external profile 14 to screen the vertical side 20′ thereof, opposite the side 20 adjacent to the wall 66.

Alternatively, in the case in which the need should arise to attach the sliding guide 10 to the ceiling, as shown in FIG. 7, both opposites sides 20 and 20′ of the external profile 14 are screened by respective shaped supports 64, while at the ceiling, indicated as number 76, said guide 10 is attached with identical expansion plugs 68 and screws 70; the latter, in particular, are inserted in the same holes 74 created along the upper front of said external profile 14. In both cases, the attachment to the wall 66 or ceiling 76 of the guide 10 obviously entails the requirement that the connection of the external profile 14 to the shaped support 62 or to the ceiling 76 is performed prior to the introduction of the internal profile 22 in the external profile 14 and to their mutual connection.

As may be seen from the above, the advantages which the invention achieves are evident.

The apparatus of the present invention makes the systematic automatic closure of the door possible without the need to provide an electric motor with relative power systems and connections, to the advantage of the simplicity and economy of construction. The possibility, during installation, of attaching the sliding guide 10 without taking into account the inclination necessary for the purpose of closing the door by gravity is particularly advantageous, the internal profile 22 being provided for the sliding of the carriages to which said door is attached, already adequately oriented as regards inclination and stabilised in the external profile 14.

A further advantage is the possibility of attaching the sliding guide 10 both to the wall and ceiling, simply and quickly.

Despite the invention having been described above with reference to one of its embodiments, given solely by way of a non-limiting example, numerous modifications and variants will appear evident to a person skilled in the art in the light of the above description.

The present invention therefore sets out to embrace all the modifications and variants which fall within the sphere and scope of the following claims.

### LIST OF NUMERALS

Reference is made to the following List in which the elements of the present invention are identified by the numerals which appear in the description hereinabove.
10 Sliding Guide
12 Carriages
14 First or External Profile of Sliding Guide 10
16 Longitudinally Extending Slot in Sliding Guide 10
18,18′ Two Opposite Sections Separated by the Slot 16 in Sliding Guide 10
20,20′ Opposite Vertical Walls or Sides
22 Second or Internal Profile
24 Overlapping and Equidistant Parallel Fins
26-26′ Opposite Vertical Walls
28-28′ Opposite Sections Separated by Longitudinally Extending Central Slot 30
30 Longitudinally Extending Central Slot 30
32 Slots Arranged Diagonally and Extending About Halfway Up Walls 20,20′, Along Their Central Area
34 Wheels of Carriages 12
36 Door
38 Self-Tapping Screws Inserted Through Slots 32
40 Longitudinally Extending Throat Defined by Two Superposed Fins 24
42 Upper Side of Internal Profile 22
44 Floor
46 Guide
48 Conventional Bolt
50 Shaped Plate
52 Spacer
54 Buffer
56 Damper Piston
58 Nut of Bolt 48
58′ Seat
60 Deformable Rubber Washer
62,64 Shaped Supports
66 Wall
68 Expansion Plugs
70 Relative Screws
72 Conventional Screws Inserted in Holes 74
74 Holes
76 Ceiling of Guide 10

1. An apparatus for the mechanical and automatic closure of sliding doors separating rooms and premises, in particular for sliding doors (36) attached to carriages (12) with wheels (34) and designed for example for service spaces for the disabled, for hospitals and public premises, comprising a sliding guide (10) consisting of a first or external profile (14) and a second or internal profile (22) positioned and stabilised in the outer profile with an inclined orientation and provided with sections (28-28′) on which said wheels (34) of said carriages (12) rest and slide, characterised in that the external (14) and internal (22) profiles define a substantially quadrangular cross-section, with respective and opposite parallel sides (20-20′) and (26-26′), wherein the bottom side has respective longitudinally extending slots (16), (30) from which a bolt (48) coming out of each carriage (12) projects.

2. The apparatus according to claim 1, characterised in that the bolt (48) coming out of each carriage (12) connects to a shaped plate (50) attached to the upper edge of each door (36).

3. The apparatus according to claim 1, characterised in that the sections (28-28′) of the internal profile (22) consist of 90° folds in the direction of the longitudinal axis of the ends of said sides (26-26′) the corresponding ends of the sides (20-20′) of the external profile (14) being similarly folded at 90° in the same direction to form opposite sections (18-18′) positioned below the sections (28-28′).

4. The apparatus according to claim 3, characterised in that at one end the sections (28-28′) of the internal profile (22) abut with the underlying sections (18-18′) of the external profile (14).

5. The apparatus according to claim 3, characterised in that from the opposite sides (26-26′) of the internal profile (22) a plurality of superposed and parallel fins (24) project which in pairs define grooves (40) for screwing the screws (38).

6. The apparatus according to claim 3, characterised in that the sides (20-20′) of the external profile (14) are provided with a plurality of spaced slots (32), arranged diagonally and alternating as regards inclination, in which said screws (38) are inserted to screw into one of the grooves (40) formed by the fins (24) of the internal profile, said latter abutting at one end the highest point “A” of the external profile (14) in opposition to the opposite end where the sections (28-28′) of the internal profile (22) abut with the sections (18-18′) of the external profile (14).

7. The apparatus according to claim 1, characterised in that a spacer (52) is combined with the bolt (48) of one or more of the carriages (12) to keep the door (36) constantly aligned with the floor (44) during the stroke of said carriages along the internal profile (22) inclined with respect to the external profile (14).

8. The apparatus according to claim 7, characterised in that the bolt (48) comprises a nut (58) in which the upper and lower opposite sides define a “cradle” shaping which allows its tilting movement in the seat (58′) which it is placed in, said nut (58) being combined with a deformable rubber washer (60).

9. The apparatus according to claim 1, characterised in that the sliding guide (10) has shaped supports (62) and/or (64), coupled to the external profile (14) for the attachment to the wall or ceiling of said guide (10).

10. The apparatus according to claim 5, characterised in that the sides (20-20′) of the external profile (14) are provided with a plurality of spaced slots (32), arranged diagonally and alternating as regards inclination, in which said screws (38) are inserted to screw into one of the grooves (40) formed by the fins (24) of the internal profile, said latter abutting at one end the highest point “A” of the external profile (14) in opposition to the opposite end where the sections (28-28′) of the internal profile (22) abut with the sections (18-18′) of the external profile (14).

11. An apparatus for the mechanical and automatic closure of sliding doors separating rooms and premises, in particular for sliding doors (36) attached to carriages (12) with wheels (34) and designed for example, for service spaces for the disabled, for hospitals and public premises, comprising a sliding guide (10) consisting of a first external profile (14) and a second internal profile (22), said internal profile positioned and stabilized in said external profile with an inclined orientation and provided with sections (28-28′) on which said wheels (34) of said carriages (12) rest and slide, characterized in that said external profile (14) and said internal profile (22) define a substantially quadrangular cross-section, with respective and opposite parallel sides (20-20′) and (26-26′), wherein the bottom side has respective longitudinally extending slots (16), (30) from which a bolt (48) coming out of each carriage (12) projects, said sections (28-28′) of said internal profile (22) consisting of 90° folds in the direction of a longitudinal axis of the ends of said sides (26-26′), and the corresponding ends of the sides (20-20′) of the external profile (14) are similarly folded at 90° in the same direction, to form opposite sections (18-18′) positioned below said sections (28-28′).

12. The apparatus according to claim 11, characterized in that the bolt (48) coming out of each carriage (12) connects to a shaped plate (50) attached to the upper edge of each door (36).

13. The apparatus according to claim 12, characterised in that at one end the sections (28-28′) of the internal profile (22) abut with the underlying sections (18-18′) of the external profile (14).

14. The apparatus according to claim 13, characterised in that from the opposite sides (26-26′) of the internal profile (22) a plurality of superposed and parallel fins (24) project which in pairs define grooves (40) for screwing the screws (38).

15. The apparatus according to claim 14, characterised in that the sides (20-20′) of the external profile (14) are provided with a plurality of spaced slots (32), arranged diagonally and alternating as regards inclination, in which said screws (38) are inserted to screw into one of the grooves (40) formed by the fins (24) of the internal profile, said latter abutting at one end the highest point “A” of the external profile (14) in opposition to the opposite end where the sections (28-28′) of the internal profile (22) abut with the sections (18-18′) of the external profile (14).

16. The apparatus according to claim 15, characterised in that a spacer (52) is combined with the bolt (48) of one or more of the carriages (12) to keep the door (36) constantly aligned with the floor (44) during the stroke of said carriages (12) along the internal profile (22) inclined with respect to the external profile (14).

17. The apparatus according to claim 16, characterised in that the bolt (48) comprises a nut (58) in which the upper and lower opposite sides define a “cradle” shaping which allows its tilting movement in the seat (58′) which it is placed in, said nut (58) being combined with a deformable rubber washer (60).

18. The apparatus according to claim 11, characterised in that the sliding guide (10) has shaped supports (62) and/or (64), coupled to the external profile (14) for the attachment to the wall or ceiling of said guide (10).

19. An apparatus for the mechanical and automatic closure of sliding doors separating rooms and premises, in particular for sliding doors (36) attached to carriages (12) with wheels (34) and designed for example for service spaces for the disabled, for hospitals and public premises, comprising a sliding guide (10) consisting of a first external profile (14) and a second internal profile (22), said internal profile positioned and stabilised in said external profile with an inclined orientation and provided with sections (28-28′) on which said wheels (34) of said carriages (12) rest and slide, characterised in that said external profile (14) and said internal profile (22) define a substantially quadrangular cross-section, with respective and opposite parallel sides (20-20′) and (26-26′), wherein the bottom side has respective longitudinally extending slots (16), (30) from which a bolt (48) coming out of each carriage (12) projects, and further characterised in that a spacer (52) is combined with said bolt (48) of one or more of said carriages (12) to keep the door (36) constantly aligned with the floor (44) during the stroke of said carriages (12) along the internal profile (22) inclined with respect to said external profile (14).

20. The apparatus according to claim 19, characterised in that the bolt (48) comprises a nut (58) in which the upper and lower opposite sides define a “cradle” shaping which allows its tilting movement in the seat (58′) which it is placed in, said nut (58) being combined with a deformable rubber washer (60).
